(19) United States
(12) Patent Application Publication
(10) Pub. No.: US 2015/0207989 A1
(43) Pub. Date: Jul. 23, 2015

(54) DEVICE FOR MONITORING THE EXTERNAL ENVIRONMENT OF A PLATFORM, IN PARTICULAR A NAVAL PLATFORM, PERISCOPE AND PLATFORM COMPRISING SUCH A DEVICE

(71) Applicant: DCNS, Paris (FR)

(72) Inventor: Roland Audibert, Toulon (FR)

(21) Appl. No.: 14/409,413

(22) PCT Filed: Jun. 28, 2013
(86) PCT No.: PCT/EP2013/063678

§ 371 Date: Dec. 18, 2014

(30) Foreign Application Priority Data
Jun. 28, 2012 (FR) 12 56171

(51) Int. Cl. H04N 5/232; B63G 8/38; G02B 23/08; G06F 3/14; H04N 5/262; H04N 5/225

(52) U.S. Cl. CPC H04N 5/23238; H04N 5/2628; H04N 5/2257; G02B 23/08; G06F 3/1407; B63G 8/38; H04N 2101/00

(57) ABSTRACT

This device for monitoring the external environment of a platform, in particular a military platform, comprising:
an observation mast (6) linked to the platform and comprising observation means (7) for observing the external environment,
means (10) for processing output information from the observation means (7),
viewing means (11) for viewing the environment linked to the means for processing information (10),
is characterized in that the viewing means (7) comprise at least one digital window (8), comprising an optical system and a photographic sensor, secured to the external surface of the mast (12).

### FIELD OF THE INVENTION

The present invention relates to a device for monitoring the external environment of a platform, in particular a military platform such as a naval platform.

Such a naval platform may for example be a surface ship or a submarine or vessel, in which case the device can then be a periscope-type system.

### BACKGROUND OF THE INVENTION

It is known that the periscopes currently used in submarines for example assume the form of a tube suitable for protruding from the foundation of the submarine.

Such a periscope can be moved between a position retracted in that foundation and a position deployed therefrom, such that its upper end protrudes above the surface of the water so as to allow observation of the environment.

In the state of the art, the tube of the periscope comprises windows in its upper part, behind which optical and/or electronic means are placed making it possible to view the external environment of the submarine or form an image thereof.

Thus, for example, a camera can be placed behind said window(s) to film or generally take images of the environment.

Optical means, for example with prisms and deflecting mirrors, can also be placed in this periscope between the upper part of the periscope and observation means placed for example in the lower part thereof and made available to the crew to observe the environment.

These different members can also be connected to viewing means, for example display monitors or screens of any appropriate type, made available to the crew.

One can, however, see that all of these devices have a certain number of drawbacks in terms of their complexity, bulk, reliability and/or quality-price ratio.

Indeed, the use of a window has a certain number of risks in terms of its reliability and in particular its tightness, in particular due to its surface and to the depths that current submarines may reach.

Furthermore, the quality of the observation is not optimal either, and the overall bulk of the device is relatively significant.

### SUMMARY OF THE INVENTION

The aim of the invention is therefore to resolve these problems.

To that end, the invention relates to a device for monitoring the external environment of a platform, in particular a military platform, comprising:
an observation mast linked to the platform and comprising observation means for observing the external environment,
means for processing output information from the observation means,
viewing means for viewing the environment linked to the means for processing information,
characterized in that the viewing means comprise at least one digital window (8), comprising an optical system and a photographic sensor, secured to the external surface of the mast.

According to other features of the device according to the invention, considered alone or in combination:
it comprises several digital windows arranged around the mast so as to cover a viewing field of 360° around that mast,
the means for observing the environment are placed on the outer surface of one end of the mast,
the digital window is adhered on the mast,
the sensor is a charge coupled device (CCD),
the optical system is a doublet formed by two lenses alongside each other, a first lens being oriented toward the external environment and a second lens being oriented toward the sensor,
the first lens is made from polymethyl methacrylate; and
the optical system is a multi-facet lens system.

According to another aspect, the invention also relates to a periscope of a naval platform, characterized in that it comprises at least one device as previously described.

Lastly, according to still another aspect, the invention also relates to a naval platform, characterized in that it comprises at least one periscope as described.

### BRIEF DESCRIPTION OF THE DRAWINGS

The invention will be better understood using the following description, provided solely as an example and done in reference to the appended drawings, in which:

FIG. 1 shows a block diagram illustrating one example embodiment of a monitoring device, for example a periscope, incorporated into a submarine foundation,

FIG. 2 illustrates a partial view of a monitoring device according to the invention, and

FIGS. 3 and 4 show cross-sectional views of two embodiments of a digital window in the composition of a device according to the invention.

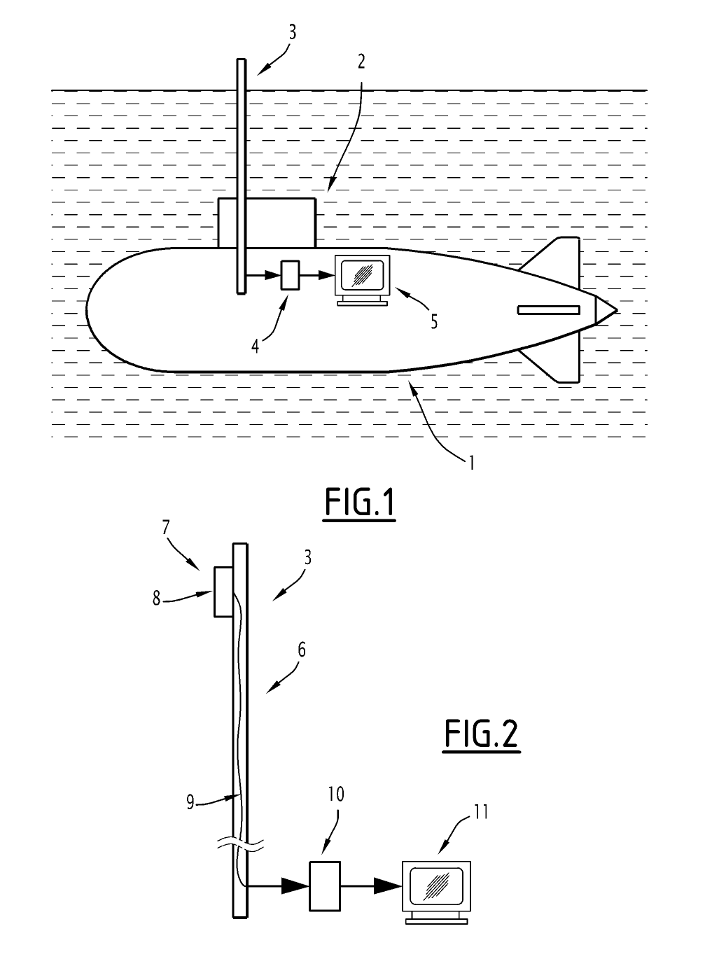

FIG. 1 in fact shows a submarine, designated by general reference 1 and equipped with a foundation designated by general reference 2.

This foundation traditionally comprises, among other equipment, a periscope designated by general reference 3, which generally assumes the form of the telescoping tubes suitable for being moved between a position retracted into the foundation and a position deployed therefrom such that its upper end protrudes above the surface of the water.

It is thus possible to observe the external environment of the submarine.

### DETAILED DESCRIPTION OF THE PREFERRED EMBODIMENT

In the state of the art, the periscope, which for example assumes the form of a tube, for example comprises a camera at its upper part that is placed behind a window of the periscope head.

Connecting means for the output of that camera are then used to transmit corresponding signals to processing means designated by general reference 4 in this figure, the output of which is connected to viewing means, for example any monitor or screen designated by general reference 5, provided to the crew to observe the external environment.

As previously indicated, this has a certain number of drawbacks.

To resolve these problems and as illustrated in FIG. 2, in the monitoring device according to the invention, the viewing means comprise at least one digital window, comprising an associated optical system and photographic sensor, fastened on the outer surface of the mast.

It should be noted that in the present patent application, the term “mast” must be understood broadly as encompassing any appropriate support structure for the rest of the system.

This is for example illustrated in FIG. 2, which shows the periscope, still designated by general reference 3, and therefore comprises an observation mast designated by general reference 6 in this figure.

That mast is connected to the platform, i.e., the rest of the submarine, and more particularly to the foundation thereof.

The upper part of that mast comprises means for observing the external environment.

These observation means are designated by general reference 7 in this FIG. 2 and, according to the invention, comprise at least one digital window designated by general reference 8, which, as will be described in more detail below, comprises an associated optical system and photographic sensor.

In fact, this digital window is fixed on the outer surface of the mast 6 in the upper part thereof.

This digital window is further connected by connecting means, for example output information transmission means of that digital window, designated by general reference 9, to information processing means 10, comprising any appropriate computer, and the output of which is connected to a monitor or any other information viewing means, designated by general reference 11, made available to the crew to observe the external environment, for example of the submarine.

In fact and according to one example embodiment of a device according to the invention, this device can comprise several digital windows arranged around the mast so as to cover a viewing field of 360° around that mast.

As previously indicated, this digital window is therefore placed on the outer surface of the upper end of the mast and can for example be adhered on a corresponding receiving surface thereof.

Of course, different embodiments and different manners of fixing said window(s) on the mast can be considered.

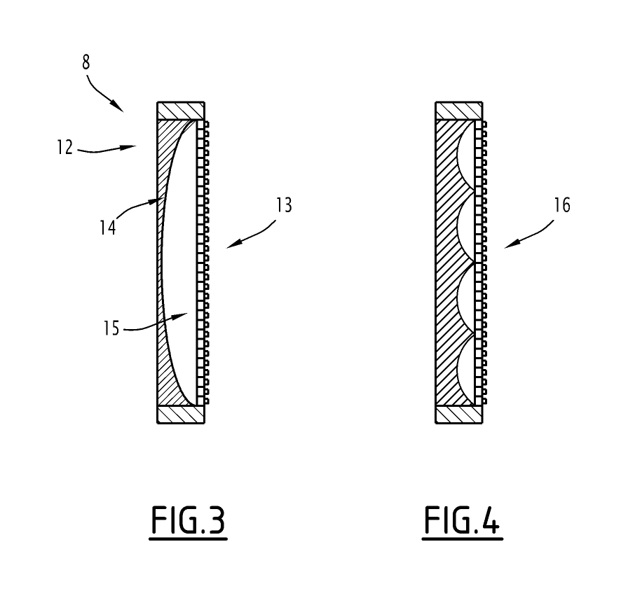

FIG. 3 shows a cross-sectional view of one example embodiment of such a digital window.

This digital window is still designated by general reference 8 in this FIG. 3.

This digital window 8 then comprises an optical system designated by general reference 12 in this figure and a photographic sensor designated by general reference 13.

In fact, the optical system 12 can assume the form of an optical doublet comprising a first lens 14 and a second lens 15, alongside each other, in front of the photographic sensor 13.

The first lens 14 can be a planar-convex lens and the second lens 15 can be a concave lens.

The first lens 14 is oriented toward the outside environment of the device, while the second lens 15 is oriented toward the sensor 13.

The first lens can for example be made from polymethyl methacrylate, while the second lens can for example be made from glass or another material.

The photographic sensor 13 is preferably made from a charge coupled sensor, also called CCD sensor.

This type of sensor is well known in the state of the art and will therefore not be described in more detail below.

FIG. 4 illustrates an alternative embodiment of an optical system 16 with multi-facet lenses.

One can then see that such a structure has a certain number of advantages relative to the systems of the state of the art.

In fact, the bulk of such a device is extremely reduced relative to that of the systems of the state of the art, and its reliability is increased relative to that of those earlier devices.

Given that the digital window in the composition of the device according to the invention is fastened on the outer surface of the mast, there is no longer any problem of resistance to submersion of that window.

Lastly, the cost of incorporating this device is also reduced while making it possible to obtain a higher quality image and greater reliability.

1. A device for monitoring the external environment of a platform, comprising:
an observation mast linked to the platform;
at least one digital window configured to observe the external environment, said digital window comprising an optical system and a photographic sensor, secured to the external surface of the mast;
a processor configured to process output information from the digital window,
a viewer configured to view the environment linked to the processor

2. The device according to claim 1, wherein the at least one digital window comprises a plurality of digital windows arranged around the mast so as to cover a viewing field of 360° around that mast.

3. The device according to claim 1, wherein the digital window is placed on the outer surface of one end of the mast.

4. The device according to claim 1, wherein the digital window is adhered on the mast.

5. The device according to claim 1, wherein the sensor is a charge coupled device (CCD).

6. The device according to claim 1, wherein the optical system is a doublet formed by two lenses alongside each other, a first lens being oriented toward the external environment and a second lens being oriented toward the sensor.

7. The device according to claim 1, wherein the optical system is a multi-facet lens system.

8. The device according to claim 6, wherein the first lens is made from polymethyl methacrylate.

9. A periscope of a naval platform, comprising at least one device according to claim 1.

10. A naval platform comprising at least one periscope according to claim 9.
